(19) United States
(12) Patent Application Publication
(10) Pub. No.: US 2026/0147587 A1
(43) Pub. Date: May 28, 2026

(54) SYSTEM AND METHOD FOR AUTOMATED PLANNING ASSISTANT

(71) Applicant: JPMorgan Chase Bank, N.A., New York, NY (US)

(72) Inventors: Daniel BORRAJO, Pozuelo de Alarcon (ES); Manuela VELOSO, New York, NY (US); Giuseppe CANONACO, Milano (IT)

(73) Assignee: JPMorgan Chase Bank, N.A., New York, NY (US)

(21) Appl. No.: 18/894,868

(22) Filed: Sep. 24, 2024

(51) Int. Cl. G06F 9/451; H04L 51/02

(52) U.S. Cl. CPC G06F 9/451; H04L 51/02

(57) ABSTRACT

Various methods and processes, apparatuses/systems, and media for automatically generating on-demand sequence of actions that integrate different frequently used computer implemented tools are disclosed. A processor causes an application to receive input data from a user via a communication interface, wherein the input data includes action model, initial state, and goals set by the user; dynamically creates the sequence of actions corresponding to the goals from the initial state by using an artificial intelligence planner included within the one or more computer implemented tools, each computer implemented tool being configured to output data different from other computer implemented tool; executes the sequence of actions and checks for successful execution; recomputes the sequence of actions when a failure of successful execution is detected; and transmits the recomputed sequence of actions to a display device utilized by the user.

### TECHNICAL FIELD

This disclosure generally relates to data processing, and, more particularly, to methods and apparatuses for automated planning assistant.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Today's orchestration tools may have access to an ever-increasing amount of different functions, services, and information via the Internet and from other computer implemented tools. The functionality of such orchestration tools appears to be rapidly increasing as many consumer devices, smart phones, tablet computers, and the like, are able to execute software applications to perform various tasks and provide various information. Each application, function, website, or feature often has its own user interface and operating paradigm, many of which may be too much to learn or burdensome for users.

Some office-related tasks may be repetitive, but varied in terms of the goals to be achieved. As an example, suppose that a user would like to generate a slide presentation with bar charts of columns of a given dataset, and send it by email to someone. At a later time, the user might want to train a classifier with a dataset that comes in an email, and wants to send out the resulting model by email to someone else. However, there appears to be no known tools that may dynamically and automatically compose such tasks and execute them.

For example, typical orchestration tools may allow users to manually define workflows or plans (i.e., sequence of actions) to execute a task. However, there appears to be no automation on automatically building those workflows or plans from received inputs. Also, if the workflow has to be adapted to different inputs/outputs, it has to be manually modified to account for other inputs as the ones they were defined for, thereby adding complexity to the overall system or process, failing to resolve data integration or synchronization or transfer issues among various computer implemented tools having various heterogenous systems running therein and subjecting the overall systems to malicious cyber-attacks due to the manual nature of defining tasks.

Some conventional orchestration tools may incorporate process mining techniques which may allow users to infer workflows from examples. However, these conventional techniques require examples, and additionally, the users should check for the correctness of the induced workflows.

Thus, today's conventional orchestration tools fail to dynamically and automatically compose workflows or plans and execute them.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic automated planning assistant module configured to implement artificial intelligence techniques to automatically and dynamically generate a workflow or a plan (sequence of actions) that may achieve goals specified by a user, execute the plan, monitor the execution of the plan, and replan when there is any failure in the execution, but the disclosure is not limited thereto.

In some embodiments, the present disclosure, through one or more of its various aspects, embodiments, and/or specific features or sub-components, also provides, among other features, various systems, servers, devices, methods, media, programs, and platforms for implementing a platform, language, cloud, and database agnostic automated planning assistant module configured to implement artificial intelligence techniques to automatically and dynamically: generate on-demand processes (plans) that integrate different frequently used tools; execute those processes, checking for successful execution; recompute processes when failures of execution are detected; redefine process goals when needed; integrate capabilities into a generic framework that easily allows including new tools, etc., thereby adding simplicity to the overall system or process, resolving data integration or synchronization or transfer issues among various computer implemented tools having various heterogenous systems running therein and protecting the overall system and network from being attacked by malicious systems, but the disclosure is not limited thereto.

In some embodiments, a method for automatically and dynamically generating on-demand sequence of actions that integrate different frequently used computer implemented tools by utilizing one or more processors along with allocated memory is disclosed. The method may include: establishing a communication link between an application and one or more computer implemented tools via a communication interface, wherein each computer implemented tool being configured to output data different from other computer implemented tool; receiving, by the application embedded within at least one processor, input data from a user via the communication interface, wherein the input data includes action model, initial state, and goals set by the user; dynamically creating the sequence of actions corresponding to the goals from the initial state by using an artificial intelligence planner included within the one or more computer implemented tools; executing the sequence of actions and checking for successful execution; recomputing the sequence of actions when a failure of successful execution is detected; and transmitting the recomputed sequence of actions to a display device utilized by the user.

In some embodiments, the method may further include: calling the one or more computer implemented tools via corresponding Application Programming Interface (API).

In some embodiments, the method may further include: integrating the application to a first computer implemented tool among the one or more computer implemented tools that is configured for: reading an electronic mail, sending an electronic mail to another device, parsing electronic mail and replying to electronic mail.

In some embodiments, the method may further include: integrating the application to a second computer implemented tool among the one or more computer implemented tools that may be configured for: creating a slide, adding a chart to the slide, adding a text to the slide, adding a table to the slide, creating a slide deck, and saving the slide deck.

In some embodiments, the method may further include: integrating the application to a third computer implemented tool among the one or more computer implemented tools that may be configured for: reading a Portable Document Format (PDF) file, extracting text from the PDF file, and saving a text file corresponding to the extracted text from the PDF file.

In some embodiments, the method may further include: integrating the application to a fourth computer implemented tool among the one or more computer implemented tools that may be configured for: extracting all appointments data in connection with the user or a party the user wants to communicate with, adding appointment to a calendar within the fourth computer implemented tool.

In some embodiments, the method may further include: integrating the application to a fifth computer implemented tool among the one or more computer implemented tools that may be configured for: reading a data file, extracting column contents from the data file, extracting column histogram from the data file, and saving the data file.

In some embodiments, the method may further include: integrating the application to a sixth computer implemented tool among the one or more computer implemented tools that may be configured for: training a supervised machine learning model.

The disclose is not limited to the first to sixth computer implemented tools. In some embodiments, the method and system disclosed herein may be configured to integrating any number of computer implemented tools that may aid in automatically and dynamically generating sequence of actions corresponding to received desired goals from a user.

In some embodiments, the method may further include: implementing a learning component that may adapt the supervised machine learning model according to an observed trace of execution.

In some embodiments, the method may further include: redefining the goals set by the user when failures of execution are detected; and dynamically creating new sequence of actions corresponding to the redefined goals.

In some embodiments, a system for automatically and dynamically generating on-demand sequence of actions that integrate different frequently used computer implemented tools is disclosed. The system may include: a processor; and a memory operatively connected to the processor via a communication interface, the memory storing computer readable instructions, when executed, may cause the processor to: establish a communication link between an application and one or more computer implemented tools via the communication interface, wherein each computer implemented tool being configured to output data different from other computer implemented tool; receive, by the application embedded within the processor, input data from a user via the communication interface, wherein the input data includes action model, initial state, and goals set by the user; dynamically create the sequence of actions corresponding to the goals from the initial state by using an artificial intelligence planner included within the one or more computer implemented tools; execute the sequence of actions and checking for successful execution; recompute the sequence of actions when a failure of successful execution is detected; and transmit the recomputed sequence of actions to a display device utilized by the user.

In some embodiments the processor may be further configured to: call the one or more computer implemented tools via corresponding API.

In some embodiments the processor may be further configured to integrate the application to a first computer implemented tool among the one or more computer implemented tools that may be configured for: reading an electronic mail, sending an electronic mail to another device, parsing electronic mail and replying to electronic mail.

In some embodiments the processor may be further configured to integrate the application to a second computer implemented tool among the one or more computer implemented tools that may be configured for: creating a slide, adding a chart to the slide, adding a text to the slide, adding a table to the slide, creating a slide deck, and saving the slide deck.

In some embodiments the processor may be further configured to integrate the application to a third computer implemented tool among the one or more computer implemented tools that may be configured for: reading a PDF file, extracting text from the PDF file, and saving a text file corresponding to the extracted text from the PDF file.

In some embodiments the processor may be further configured to integrate the application to a fourth computer implemented tool among the one or more computer implemented tools that may be configured for: extracting all appointments data in connection with the user or a party the user wants to communicate with, adding appointment to a calendar within the fourth computer implemented tool.

In some embodiments the processor may be further configured to integrate the application to a fifth computer implemented tool among the one or more computer implemented tools that may be configured for: reading a data file, extracting column contents from the data file, extracting column histogram from the data file, and saving the data file.

In some embodiments the processor may be further configured to integrate the application to a sixth computer implemented tool among the one or more computer implemented tools that may be configured for: training a supervised machine learning model.

In some embodiments, the processor may be further configured to implement a learning component that may adapt the supervised machine learning model according to an observed trace of execution.

In some embodiments, the processor may be further configured to: redefine the goals set by the user when failures of execution are detected; and dynamically create new sequence of actions corresponding to the redefined goals.

In some embodiments, a non-transitory computer readable medium configured to store instructions for automatically and dynamically generating on-demand sequence of actions that integrate different frequently used computer implemented tools is disclosed. The instructions, when executed, may cause a processor to perform the following: establishing a communication link between an application and one or more computer implemented tools via a communication interface, wherein each computer implemented tool being configured to output data different from other computer implemented tool; receiving, by the application embedded within at least one processor, input data from a user via the communication interface, wherein the input data includes action model, initial state, and goals set by the user; dynamically creating the sequence of actions corresponding to the goals from the initial state by using an artificial intelligence planner included within the one or more computer implemented tools; executing the sequence of actions and checking for successful execution; recomputing the sequence of actions when a failure of successful execution is detected; and transmitting the recomputed sequence of actions to a display device utilized by the user.

In some embodiments, the instructions, when executed, may cause the processor to further perform the following: calling the one or more computer implemented tools via corresponding API.

In some embodiments, the instructions, when executed, may cause the processor to further perform the following: integrating the application to a first computer implemented tool among the one or more computer implemented tools that is configured for: reading an electronic mail, sending an electronic mail to another device, parsing electronic mail and replying to electronic mail.

In some embodiments, the instructions, when executed, may cause the processor to further perform the following: integrating the application to a second computer implemented tool among the one or more computer implemented tools that may be configured for: creating a slide, adding a chart to the slide, adding a text to the slide, adding a table to the slide, creating a slide deck, and saving the slide deck.

In some embodiments, the instructions, when executed, may cause the processor to further perform the following: integrating the application to a third computer implemented tool among the one or more computer implemented tools that may be configured for: reading a PDF file, extracting text from the PDF file, and saving a text file corresponding to the extracted text from the PDF file.

In some embodiments, the instructions, when executed, may cause the processor to further perform the following: integrating the application to a fourth computer implemented tool among the one or more computer implemented tools that may be configured for: extracting all appointments data in connection with the user or a party the user wants to communicate with, adding appointment to a calendar within the fourth computer implemented tool.

In some embodiments, the instructions, when executed, may cause the processor to further perform the following: integrating the application to a fifth computer implemented tool among the one or more computer implemented tools that may be configured for: reading a data file, extracting column contents from the data file, extracting column histogram from the data file, and saving the data file.

In some embodiments, the instructions, when executed, may cause the processor to further perform the following: integrating the application to a sixth computer implemented tool among the one or more computer implemented tools that may be configured for: training a supervised machine learning model.

In some embodiments, the instructions, when executed, may cause the processor to further perform the following: implementing a learning component that may adapt the supervised machine learning model according to an observed trace of execution.

In some embodiments, the instructions, when executed, may cause the processor to further perform the following: redefining the goals set by the user when failures of execution are detected; and dynamically creating new sequence of actions corresponding to the redefined goals.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic automated planning assistant module configured to automatically and dynamically generate on-demand sequence of actions that integrate different frequently used computer implemented tools in accordance with an embodiment.

FIG. 2 illustrates a diagram of a network environment with a platform, language, database, and cloud agnostic automated planning assistant device in accordance with an embodiment.

FIG. 3 illustrates a system diagram for implementing a platform, language, database, and cloud agnostic automated planning assistant device having a platform, language, database, and cloud agnostic automated planning assistant module in accordance with an embodiment.

FIG. 4 illustrates a system diagram for implementing a platform, language, database, and cloud agnostic automated planning assistant module of FIG. 3 in accordance with an embodiment.

FIG. 5 illustrates a flow chart of a process implemented by the platform, language, database, and cloud agnostic automated planning assistant module of FIG. 4 for automatically and dynamically generating on-demand sequence of actions that integrate different frequently used computer implemented tools in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

For example, typical orchestration tools may allow users to manually define workflows or plans (i.e., sequence of actions) to execute a task. However, there appears to be no automation on automatically building those workflows or plans from received inputs. Also, if the workflow has to be adapted to different inputs/outputs, it has to be manually modified to account for other inputs as the ones they were defined for, thereby adding complexity to the overall system or process, failing to resolve data integration or synchronization or transfer issues among various computer implemented tools having various heterogenous systems running therein and subjecting the overall systems to malicious cyber-attacks due to the manual nature of defining tasks. Some conventional orchestration tools may incorporate process mining techniques which may allow users to infer workflows from examples. However, these conventional techniques require examples, and additionally, the users should check for the correctness of the induced workflows. Thus, today's conventional orchestration tools fail to dynamically and automatically compose workflows or plans and execute them.

The present disclosure, through one or more of its various aspects, embodiments, and/or specific features or sub-components, provides, among other features, various systems, servers, devices, methods, media, programs, and platforms for implementing a platform, language, cloud, and database agnostic automated planning assistant module configured to implement artificial intelligence techniques to automatically and dynamically generate a workflow or a plan (sequence of actions) that may achieve goals specified by a user, execute the plan, monitor the execution of the plan, and replan when there is any failure in the execution, but the disclosure is not limited thereto.

In some embodiments, the present disclosure, through one or more of its various aspects, embodiments, and/or specific features or sub-components, also provides, among other features, various systems, servers, devices, methods, media, programs, and platforms for implementing a platform, language, cloud, and database agnostic automated planning assistant module configured to implement artificial intelligence techniques to automatically and dynamically: generate on-demand processes (plans) or workflows that integrate different frequently used tools; execute those processes, checking for successful execution; recompute processes when failures of execution are detected; redefine process goals when needed; integrate capabilities into a generic framework that easily allows including new tools, etc., thereby adding simplicity to the overall system or process, resolving data integration or synchronization or transfer issues among various computer implemented tools having various heterogenous systems running therein and protecting the overall system and network from being attacked by malicious systems, but the disclosure is not limited thereto.

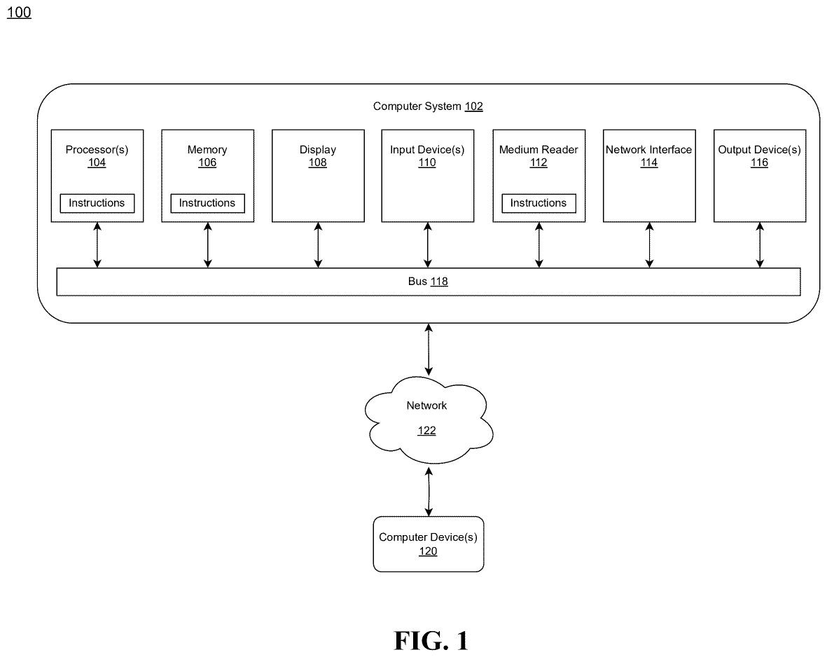

FIG. 1 is an exemplary system 100 for use in implementing a platform, language, database, and cloud agnostic automated planning assistant module configured to automatically and dynamically generate automatically generate on-demand sequence of actions that integrate different frequently used computer implemented tools in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the automated planning assistant module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the automated planning assistant module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

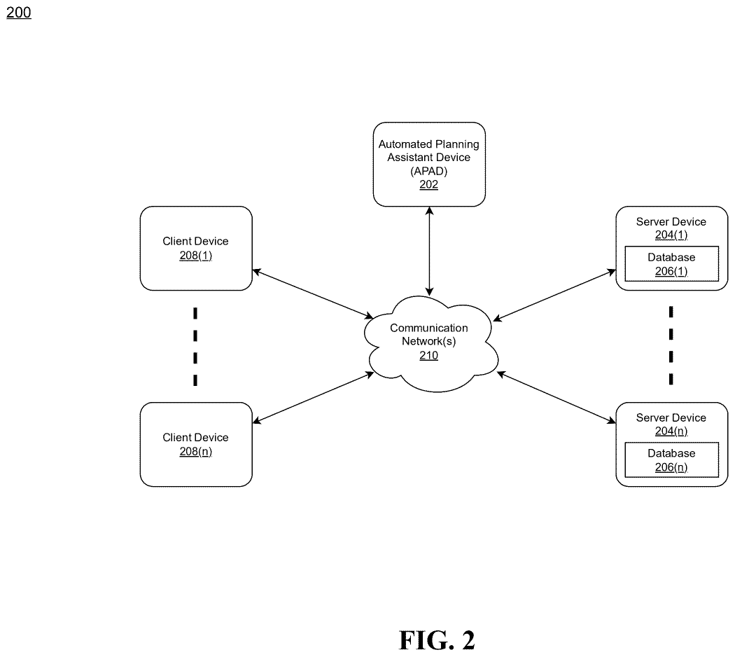

Referring to FIG. 2, a schematic of an exemplary network environment 200 for implementing a language, platform, database, and cloud agnostic automated planning assistant device (APAD) of the instant disclosure is illustrated.

In some embodiments, the above-described problems associated with conventional tools may be overcome by implementing an APAD 202 as illustrated in FIG. 2 that may be configured for implementing a platform, language, database, and cloud agnostic automated planning assistant module configured to implement artificial intelligence techniques to automatically and dynamically generate a plan (sequence of actions) or a workflow that may achieve goals specified by a user, execute the plan, monitor the execution of the plan, and replan when there is any failure in the execution, but the disclosure is not limited thereto. Dynamically, within the scope of the present disclosure may mean that the APAD 202 may adapt to the goals of the workflow and the received inputs that are provided. As opposed to static, where users define a fixed set of actions in a particular order that form the workflow. That is, the APAD 202 may be configured to generate different workflows that adapt to the received inputs.

The APAD 202 may have one or more computer system 102s, as described with respect to FIG. 1, which in aggregate provide the necessary functions.

The APAD 202 may store one or more applications that may include executable instructions that, when executed by the APAD 202, cause the APAD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the APAD 202 itself, may be located in virtual server(s) running in a cloud-based computing environment rather than being tied to one or more specific physical network computing devices. Also, the application(s) may be running in one or more virtual machines (VMs) executing on the APAD 202. Additionally, in one or more embodiments of this technology, virtual machine(s) running on the APAD 202 may be managed or supervised by a hypervisor.

In the network environment 200 of FIG. 2, the APAD 202 may be coupled to a plurality of server devices 204(1)-204(n) that hosts a plurality of databases 206(1)-206(n), and also to a plurality of client devices 208(1)-208(n) via communication network(s) 210. A communication interface of the APAD 202, such as the network interface 114 of the computer system 102 of FIG. 1, operatively couples and communicates between the APAD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the APAD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The APAD 202 may be a standalone device or integrated with one or more other devices or apparatuses, such as one or more of the server devices 204(1)-204(n). In some embodiments, the APAD 202 may be hosted by one of the server devices 204(1)-204(n), and other arrangements may also be possible. Moreover, one or more of the devices of the APAD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the APAD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the APAD 202 that may efficiently provide a platform for implementing a platform, language, database, and cloud agnostic automated planning assistant module configured to implement artificial intelligence techniques to automatically and dynamically generate a plan (sequence of actions) that may achieve goals specified by a user, execute the plan, monitor the execution of the plan, and replan when there is any failure in the execution, but the disclosure is not limited thereto.

The client devices 208(1)-208(n) may run interface applications, such as standard web browsers or standalone client applications, which may provide an interface to communicate with the APAD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the APAD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the APAD 202, the server devices 204(1)-204(n), or the client devices 208(1)-208(n), in some embodiments, may be configured to operate as virtual instances on the same physical machine. In some embodiments, one or more of the APAD 202, the server devices 204(1)-204(n), or the client devices 208(1)-208(n) may operate on the same physical device rather than as separate devices communicating through communication network(s) 210. Additionally, there may be more or fewer APADs 202, server devices 204(1)-204(n), or client devices 208(1)-208(n) than illustrated in FIG. 2. In some embodiments, the APAD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

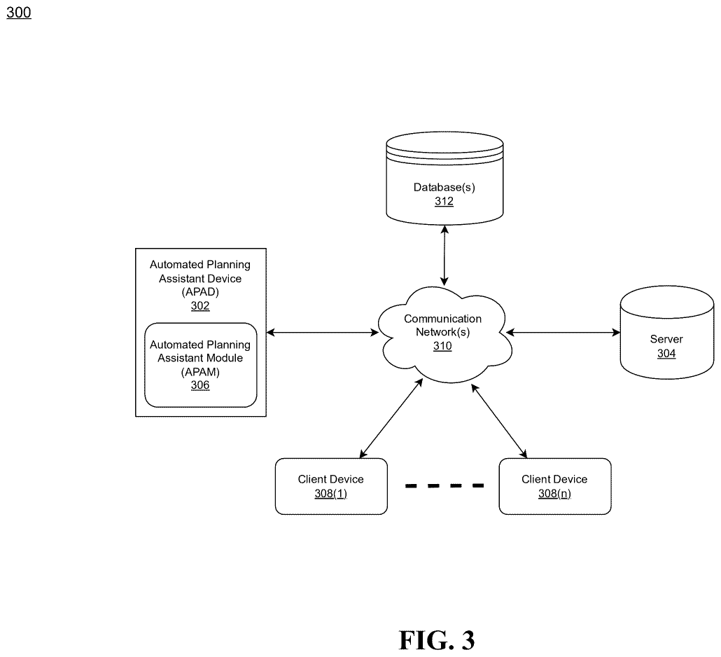

FIG. 3 illustrates a system diagram for implementing a platform, language, and cloud agnostic APAD having a platform, language, database, and cloud agnostic automated planning assistant module (APAM) in accordance with an embodiment.

As illustrated in FIG. 3, the system 300 may include an APAD 302 within which an APAM 306 may be embedded, a server 304, a database(s) 312, a plurality of client devices 308(1) . . . 308(n), and a communication network 310.

In some embodiments, the APAD 302 including the APAM 306 may be connected to the server 304, and the database(s) 312 via the communication network 310. The APAD 302 may also be connected to the plurality of client devices 308(1) . . . 308(n) via the communication network 310, but the disclosure is not limited thereto.

According to exemplary embodiment, the APAD 302 is described and shown in FIG. 3 as including the APAM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models.

In some embodiments, the APAM 306 may be configured to receive real-time feed of data from the plurality of client devices 308(1) . . . 308(n) and secondary sources via the communication network 310.

As may be described below, the APAM 306 may be configured to: establish a communication link between an application and one or more computer implemented tools via the communication interface, wherein each computer implemented tool being configured to output data different from other computer implemented tool; receive, by the application embedded within the processor, input data from a user via the communication interface, wherein the input data includes action model, initial state, and goals set by the user; dynamically create the sequence of actions corresponding to the goals from the initial state by using an artificial intelligence planner included within one or more computer implemented tools; execute the sequence of actions and checking for successful execution; recompute the sequence of actions when a failure of successful execution is detected; and transmit the recomputed sequence of actions to a display device utilized by the user, but the disclosure is not limited thereto.

The plurality of client devices 308(1) . . . 308(n) are illustrated as being in communication with the APAD 302. In this regard, the plurality of client devices 308(1) . . . 308(n) may be “clients” (e.g., customers) of the APAD 302 and are described herein as such. Nevertheless, it is to be known and understood that the plurality of client devices 308(1) . . . 308(n) need not necessarily be “clients” of the APAD 302, or any entity described in association therewith herein. Any additional or alternative relationship may exist between either or both of the plurality of client devices 308(1) . . . 308(n) and the APAD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the APAD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The APAD 302 may be the same or similar to the APAD 202 as described with respect to FIG. 2, including any features or combination of features described with respect thereto.

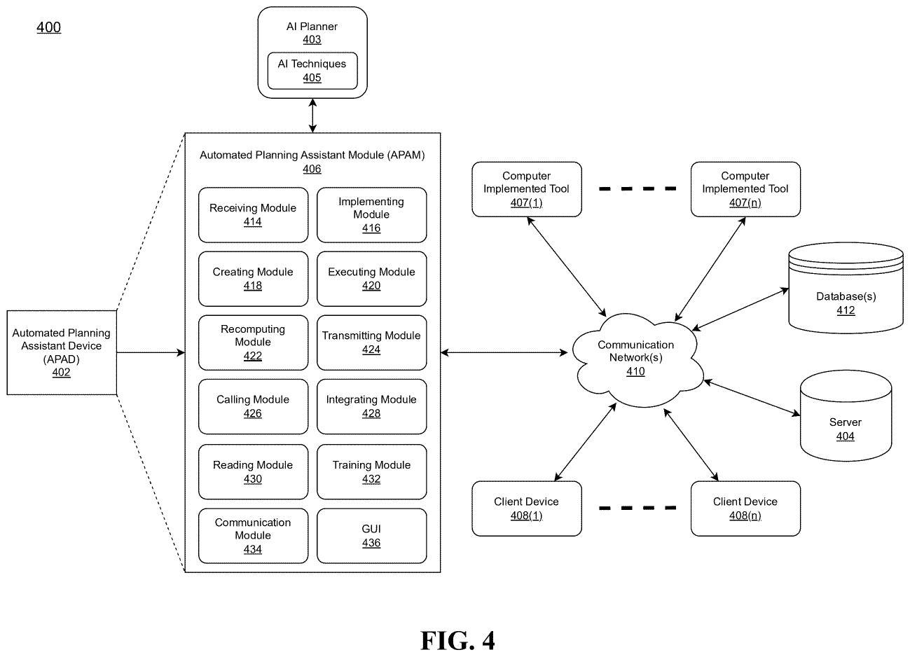

FIG. 4 illustrates a system diagram for implementing a platform, language, database, and cloud agnostic APAM of FIG. 3 in accordance with an exemplary embodiment.

In some embodiments, the system 400 may include a platform, language, database, and cloud agnostic APAD 402 within which a platform, language, database, and cloud agnostic APAM 406 may be embedded, a server 404, database(s) 412, and a communication network 410. In some embodiments, server 404 may comprise a plurality of servers located centrally or located in different locations, but the disclosure is not limited thereto.

In some embodiments, the APAD 402 including the APAM 406 may be connected to the server 404, one or more computer implemented tools 407(1)-407(n), and the database(s) 412 via the communication network 410. The APAD 402 may also be connected to the plurality of client devices 408(1)-408(n) via the communication network 410, but the disclosure is not limited thereto. The APAM 406, the server 404, the plurality of client devices 408(1)-408(n), the database(s) 412, the communication network 410 as illustrated in FIG. 4 may be the same or similar to the APAM 306, the server 304, the plurality of client devices 308(1)-308(n), the database(s) 312, the communication network 310, respectively, as illustrated in FIG. 3.

In some embodiments, as illustrated in FIG. 4, the APAM 406 may include a receiving module 414, an implementing module 416, a creating module 418, an executing module 420, a recomputing module 422, a transmitting module 424, a calling module 426, an integrating module 428, a reading module 430, a training module 432, a communication module 434, and a Graphical User Interface (GUI) 436. In some embodiments, interactions and data exchange among these modules included in the APAM 406 provide the advantageous effects of the disclosed invention. Functionalities of each module of FIG. 4 may be described in detail below with reference to FIGS. 4-6.

In some embodiments, each of the receiving module 414, implementing module 416, creating module 418, executing module 420, recomputing module 422, transmitting module 424, calling module 426, integrating module 428, reading module 430, training module 432, and the communication module 434 of the APAM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the receiving module 414, implementing module 416, creating module 418, executing module 420, recomputing module 422, transmitting module 424, calling module 426, integrating module 428, reading module 430, training module 432, and the communication module 434 of the APAM 406 of FIG. 4 may be implemented by microprocessors or similar, and may be programmed using software (e.g., microcode) to perform various functions discussed herein and may optionally be driven by firmware and/or software.

Alternatively, in some embodiments, each of the receiving module 414, implementing module 416, creating module 418, executing module 420, recomputing module 422, transmitting module 424, calling module 426, integrating module 428, reading module 430, training module 432, and the communication module 434 of the APAM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the APAM 406 of FIG. 4 may also be implemented by Cloud based deployment.

In some embodiments, each of the receiving module 414, implementing module 416, creating module 418, executing module 420, recomputing module 422, transmitting module 424, calling module 426, integrating module 428, reading module 430, training module 432, and the communication module 434 of the APAM 406 of FIG. 4 may be called via corresponding API, but the disclosure is not limited thereto. In some embodiments, calls may also be made using Event based message interfaces in addition to APIs.

In some embodiments, the process implemented by the APAM 406 may be executed via the communication module 434, and the communication network 410, which may comprise plural networks as described above. In some embodiments, in an exemplary embodiment, the various components of the APAM 406 may communicate with the server 404, and the database(s) 412 via the communication module 430 and the communication network 410 and the results may be displayed onto the GUI 436. Of course, these embodiments are merely exemplary and are not limiting or exhaustive. The database(s) 412 may include the databases included within the private cloud and/or public cloud and the server 404 may include one or more servers within the private cloud and the public cloud.

In some embodiments, the APAM 406 may be configured to implement artificial intelligence techniques 405 to automatically and dynamically generate a plan (sequence of actions) that may achieve goals specified by a user, execute the plan, monitor the execution of the plan, and replan when there is any failure in the execution, but the disclosure is not limited thereto.

In some embodiments, the APAM 406 may also be configured to implement artificial intelligence techniques 405 to automatically: generate on-demand processes (plans) that integrate different frequently used tools (i.e., computer implemented tools 407(1)-407(n)); execute those processes, checking for successful execution; recompute processes when failures of execution are detected; redefine process goals when needed; integrate capabilities into a generic framework that easily allows including new tools, etc., but the disclosure is not limited thereto.

For example, the communication module 434 may be configured to establish a communication link between an application (i.e., framework) embedded within the APAM 406 and one or more computer implemented tools 407(1)-407(n). In some embodiments, each computer implemented tool being configured to output data different from other computer implemented tool.

In some embodiments, the receiving module 414 may be configured to receive, by the application embedded within the APAM 406, input data from a user via the communication interface (i.e., communication module 434). In some embodiments, the input data may include action model, initial state, and goals set by the user, but the disclosure is not limited thereto. Exemplary initial state may include: Data in file.csv; Columns (among others): net-value, global-position, balance, year, but the disclosure is not limited thereto. Exemplary goals may include: Generate a slide presentation and save it in file presentation.pptx; and it should contain three slides, each with a bar chart: A bar chart showing net-value against year; A bar chart showing global-position against year; A bar chart showing balance against year, but the disclosure is not limited thereto. A user is free to set any other goals as desired.

In some embodiments, the implementing module 416 may be configured to implement artificial intelligence techniques 405 provided by an artificial intelligence planner 403 to output sequence of actions that achieve goals from the initial state. The creating module 418 may be configured to dynamically create the sequence of actions corresponding to the goals from the initial state by using an artificial intelligence planner 403 included within the one or more computer implemented tools 407(1)-407(n).

In some embodiments, the executing module 420 may be configured to execute the sequence of actions and checking for successful execution. The recomputing module 422 may be configured to recompute the sequence of actions when a failure of successful execution is detected. The transmitting module 424 may be configured to transmit the recomputed sequence of actions to a display device (i.e., embedded within each of the client device 408(1)-408(n)) utilized by the user. In some embodiments, the display device may be similar to the GUI 436.

In some embodiments the calling module 426 may be configured to call the one or more computer implemented tools 407(1)-407(n) via corresponding API.

In some embodiments, the integrating module 428 may be configured to integrate the application to a first computer implemented tool 407(1) among the one or more computer implemented tools 407(1)-407(n) that may be configured for: reading an electronic mail by utilizing the reading module 430, sending an electronic mail to another device, parsing electronic mail and replying to electronic mail.

In some embodiments, the integrating module 428 may be configured to integrate the application to a second computer implemented tool 407(2) among the one or more computer implemented tools 407(1)-407(n) that may be configured for: creating a slide, adding a chart to the slide, adding a text to the slide, adding a table to the slide, creating a slide deck, and saving the slide deck.

In some embodiments, the integrating module 428 may be configured to integrate the application to a third computer implemented tool 407(3) among the one or more computer implemented tools 407(1)-407(n) that may be configured for: reading a PDF file, extracting text from the PDF file, and saving a text file corresponding to the extracted text from the PDF file.

In some embodiments, the integrating module 428 may be configured to integrate the application to a fourth computer implemented tool 407(1) among the one or more computer implemented tools 407(1)-407(n) that may be configured for: extracting all appointments data in connection with the user or a party the user wants to communicate with, adding appointment to a calendar within the fourth computer implemented tool.

In some embodiments, the integrating module 428 may be configured to integrate the application to a fifth computer implemented tool 407(1) among the one or more computer implemented tools 407(1)-407(n) that may be configured for: reading a data file, extracting column contents from the data file, extracting column histogram from the data file, and saving the data file.

In some embodiments, the integrating module 428 may be configured to integrate the application to a sixth computer implemented tool 407(1) among the one or more computer implemented tools 407(1)-407(n) that may be configured for: training a supervised machine learning model.

In some embodiments, the implementing module 416 may be further configured to implement a learning component that may adapt the supervised machine learning model according to an observed trace of execution.

In some embodiments, the APAM 406 may be configured to redefine the goals set by the user when failures of execution are detected; and dynamically create new sequence of actions corresponding to the redefined goals.

In some embodiments, each action may be defined by three representations: code that executes the action (standardize action API), code that describes the action for the AI planner, i.e., APAM 406, (action definition for planning), and code that checks whether the action is executed correctly (success criteria for action).

In some embodiments, standardized action API may include:

```
def action_name (parameters, state):
  action code,
  return state.
```

In some embodiments, the action definition for planning may include:

```
action_name (parameters)
  preconditions: formula
  effects: formula
```

In some embodiments, the success criteria for action may include: def action name success (parameters, state):

```
def action_name_success (parameters, state):
  success = compute success criteria for action
  return success.
```

In some embodiments, actions representation schemes for standardized action API may include:

```
def save_text (parameters, state):
  data_var = parameters[1]
  file_var = parameters[2]
  path = state[file_var][‘value’]
  text = state[data_var][‘value’]
  with open(path, ‘w’) as f:
    f.write(text)
  print(‘saving contents of’, data_var, ‘on file’, path)
  return state.
```

In some embodiments, actions representation schemes for action definition for planning may include:

```
(:action save text
  :parameters (?a - ai-agent ?t - text ?f - text-file)
  :precondition (and (available ?t) (not (in ?t ?f)))
  :effect (in ?t ?f))
```

Corresponding to “ai-agent” every action may include an agent's parameter as who is supposed to execute action: AI or human.

In some embodiments, actions representation schemes for success criteria for action may include:

```
def save_text_success (action, state):
  file_var = action[3]
  success = (os.path.isfile(state[file_var][‘value’]))
  return success.
```

In some embodiments, a list of actions implemented in the APAM 406 framework may include the following: Reading from files: read_data, read_pdf, Saving in files: save_data, save_text; Extracting data from databases: extract_data; Creating charts for slides: create-chart, add-to-chart; Handling slides: create-slide, add-to-slide, add-text-to-slide, add-table-to-slide; Handling presentations (slide decks): create-presentation, contents-in-presentation, generate-presentation; Handling emails: send-email, read-email, parse-email; Handling Outlook appointments: read-appointments, appointments-to-data, add-to-appointments, but the disclosure is not limited thereto.

In some embodiments, actions that may need to operate on a set of objects, where each object may be of a type: File: pdf, text, data (excel, csv), powerpoint; Data: dataframe, text, chart; Chart: pie-chart, bar-chart, histogram; Contents: presentation, data-contents; Data-type: column, value-counts; Email: input-email, output-email; Agent: human-agent, ai-agent; Others: appointments, appointments-item, slide, etc., but the disclosure is not limited thereto.

In some embodiments, an example of an action model in the AI planning language Planning Domain Definition Language (PDDL) implemented by the APAM 406 may include the following:

```
(:action add-to-chart
  :parameters (?dt - data-type ?c - chart ?dc - data-contents)
  :precondition (and (not (used-chart ?c))
      (available ?c)
      (data-type-contents ?dt ?dc)
      available ?dc
  :effect (and (graph-contents ?c ?dc)
    (used-chart ?c)))
```

PDDL is a family of languages which allows to define a planning task. As planning has evolved, the APAM 406 may be configured to utilize suitable version(s) of PDDL as desired to correspond to different levels of expressivity.

In some embodiments, the APAM 406 may generate plan that may include:

read_data(data-annual-report, annual-report);
extract_data(net-value, data-annual-report, net-value-contents);
extract_data(global-position, data-annual-report, global-position-contents);
extract_data(balance, data-annual-report, balance-contents);
create-presentation(annual-report-results);
create-slide(slide3, annual-report-results); create-graph(bar-chart1);
add-to-chart(global-position, bar-chart1, global-position-contents);
create-chart (bar-chart2);
add-to-chart (balance, bar-chart2, balance-contents);
create-chart (bar-chart3);
add-to-chart (net-value, bar-chart3, net-value-contents);
create-slide(slide2, annual-report-results);
add-to-slide(bar-chart1, slide2);
contents-in-presentation(global-position-contents, bar-chart1, slide2,
annual-report-results);
create-slide(slide1, annual-report-results);
add-to-slide(bar-chart2, slide1);
contents-in-presentation(balance-contents, bar-chart2, slide1,
annual-report-results);
add-to-slide(bar-chart3, slide3);
contents-in-presentation(net-value-contents, bar-chart3, slide3,
annual-report-results);
generate-presentation(annual-report-results,
annual-report-results-file), etc.,
but the disclosure is not limited thereto.

In some embodiments, algorithm for planning, execution and monitoring of a plan as executed by the APAM 406 may include:

```
Plan = plan(domain, <initial state, goals>)
For each action in plan
  if action's agent is AI
  then
    execute action in current state
  else
    tell the human to execute the action
  current state = observe next state
  new goals = observe new goals
  if not(successful execution) or not(goals = new goals)
  then
    goals = new goals
    plan = plan(domain, <current state, goals>)
    start execution of new plan
```

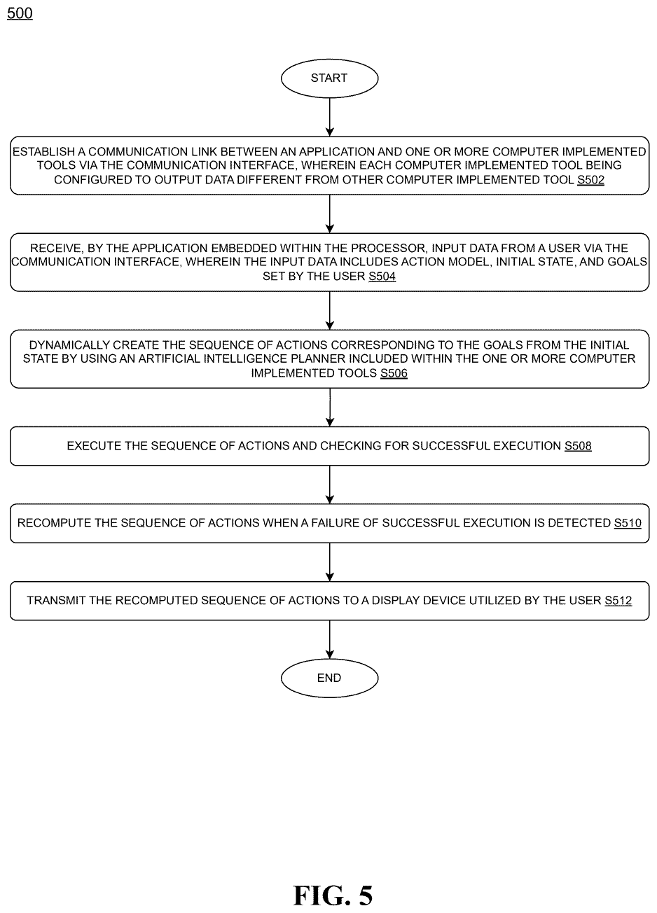

FIG. 5 illustrates an exemplary flow chart of a process 500 implemented by the platform, language, database, and cloud agnostic APAM 406 of FIG. 4 for systemically and dynamically generating on-demand sequence of actions that integrate different frequently used computer implemented tools in accordance with an exemplary embodiment. It may be appreciated that the illustrated process 500 and associated steps may be performed in a different order, with illustrated steps omitted, with additional steps added, or with a combination of reordered, combined, omitted, or additional steps.

As illustrated in FIG. 5, at step S502, the process 500 may include establishing a communication link between an application and one or more computer implemented tools via a communication interface and a communication network. In some embodiments, the communication network may be the same or similar to the communication network 210, 310, 410 as disclosed herein with reference to FIGS. 2-4. The application may be the same or similar to the APAM 406 as disclosed herein with reference to FIG. 4.

Each computer implemented tool may be configured to output data different from other computer implemented tool. The computer implemented tools may be the same or similar to the computer implemented tools 407(1)-407(n) as disclosed therein with reference to FIG. 4. For example, one computer implemented tool may output data in a .pdf format and another computer implemented tool may output data in a .pptx format, but the disclosure is not limited thereto.

At step S504, the process 500 may include receiving, by the application embedded within at least one processor, input data from a user via the communication interface. The input data may include action model, initial state, and goals set by the user.

Within the scope of the present disclosure, an action model may be a formal description of the set of actions that are available to conform any step of the generated workflows disclosed herein with reference to FIG. 4. For example, the set of actions may include, but not limited thereto, reading an email, sending an email, adding appointment, creating a slide presentation, adding a chart and/or table and/or text to the slide, training ga model, reading a PDF file, etc.

Within the scope of the present disclosure, initial state may refer to a representation of the inputs of the workflow. It may be represented formally, using predicate logic, not as functions. Exemplary initial state may include: Data in file.csv; Columns (among others): net-value, global-position, balance, year, but the disclosure is not limited thereto.

Within the scope of the present disclosure, goals may be the expected output from the workflow (e.g., a PowerPoint file sent by email). The goals may also be formally specified in predicate logic. Exemplary initial state may include: Data in file.csv; Columns (among others): net-value, global-position, balance, year, but the disclosure is not limited thereto. Exemplary goals may include: Generate a slide presentation and save it in file presentation.pptx; and it should contain three slides, each with a bar chart: A bar chart showing net-value against year; A bar chart showing global-position against year; A bar chart showing balance against year, but the disclosure is not limited thereto. A user is free to set any other goals as desired.

At step S506, the process 500 may include dynamically creating a sequence of actions corresponding to the goals from the initial state by using an artificial intelligence planner included within the one or more computer implemented tools. Within the scope of the present discloser, a sequence of actions may be an ordered list of actions that define the workflow. In order to enact the workflow, the actions should be executed in a sequence. The AI planner may include any commonly used AI planner, such as ClickUp™, AI for Google Calendar™, Motion, Kronologic, etc. In the context of artificial intelligence, an AI planner is a system or program that is intended to provide plans or action sequences to accomplish particular objectives. These planners are employed in a variety of settings where making decisions and addressing problems call for a sequence of activities or processes.

At step S508, the process 500 may include executing the sequence of actions and checking for successful execution. Each action may be defined by three representations: code that executes the action (standardize action API), code that describes the action for the AI planner, and code that checks whether the action is executed correctly (success criteria for action). In some embodiments, the success criteria for action may include:

```
def action_name_success (parameters, state):
  success = compute success criteria for action
  return success.
```

At step S510, the process 500 may include recomputing the sequence of actions when a failure of successful execution is detected. For example, if an action is supposed to create a file, and the file is not created after the execution of the corresponding function, then something went wrong. The AI planner may be called again from the current state of execution to generate another plan.

At step S512, the process 500 may include transmitting the recomputed sequence of actions to a display device utilized by the user. For example, the recomputed sequence of actions may be displayed onto the GUI 436 as illustrated in FIG. 4

In some embodiments, the process 500 may further include: calling the one or more computer implemented tools via corresponding API. As described above, each action may be associated to a function. The function may be standard Python code, or it may alternatively call an API.

In some embodiments, the process 500 may further include: integrating the application, i.e., APAM 406, to a first computer implemented tool 407(1) among the one or more computer implemented tools 407(1)-407(n) via the communication network(s) 410 and the communication module 434. The first computer implemented tool 407(1) may be configured for: reading an electronic mail, sending an electronic mail to another device, parsing electronic mail and replying to electronic mail.

In some embodiments, the process 500 may further include: integrating the application, i.e., APAM 406, to a second computer implemented tool 407(2) among the one or more computer implemented tools 407(1)-407(n) via the communication network(s) 410 and the communication module 434. The second computer implemented tool 407(2) may be configured for: creating a slide, adding a chart to the slide, adding a text to the slide, adding a table to the slide, creating a slide deck, and saving the slide deck.

In some embodiments, the process 500 may further include: integrating the application, i.e., APAM 406, to a third computer implemented tool 407(3) among the one or more computer implemented tools 407(1)-407(n) via the communication network(s) 410 and the communication module 434. The third computer implemented tool 407(3) may be configured for: reading a PDF file, extracting text from the PDF file, and saving a text file corresponding to the extracted text from the PDF file.

In some embodiments, the process 500 may further include: integrating the application, i.e., APAM 406, to a fourth computer implemented tool 407(4) among the one or more computer implemented tools 407(1)-407(n) via the communication network(s) 410 and the communication module 434. The fourth computer implemented tool 407(4) may be configured for: extracting all appointments data in connection with the user or a party the user wants to communicate with, adding appointment to a calendar within the fourth computer implemented tool.

In some embodiments, the process 500 may further include: integrating the application, i.e., APAM 406 to a fifth computer implemented tool 407(5) among the one or more computer implemented tools 407(1)-407(n) via the communication network(s) 410 and the communication module 434. The fifth computer implemented tool 407(5) may be configured for: reading a data file, extracting column contents from the data file, extracting column histogram from the data file, and saving the data file.

In some embodiments, the process 500 may further include: integrating the application, i.e., APAM 406, to a sixth computer implemented tool 407(6) among the one or more computer implemented tools 407(1)-407(n) via the communication network(s) 410 and the communication module 434. The sixth computer implemented tool 407(6) may be may be configured for: training a supervised machine learning model.

In some embodiments, the process 500 may further include: implementing a learning component that may adapt the supervised machine learning model according to an observed trace of execution by utilizing the APAD 202 as disclosed herein with reference to FIG. 2. For example, in some embodiments of this technology, virtual machine(s) running on the APAD 202 may be managed or supervised by a hypervisor. A hypervisor is a software that may be utilized to run multiple virtual machines on a single physical machine. Every virtual machine may have its own operating system and applications. The hypervisor may allocate the underlying physical computing resources such as CPU and memory to individual virtual machines as required. Supervised learning, within the context of the present disclosure may refer to a category of machine learning that uses labeled datasets to train algorithms to predict outcomes and recognize patterns. Unlike unsupervised learning, supervised learning algorithms are given labeled training to learn the relationship between the input and the outputs.

In some embodiments, the process 500 may further include: redefining the goals set by the user when failures of execution are detected by the APAM 406; and dynamically creating new sequence of actions corresponding to the redefined goals by calling the creating module 418 via a corresponding API.

In some embodiments, the APAD 402 may include a memory (e.g., a memory 106 as illustrated in FIG. 1) which may be a non-transitory computer readable medium that may be configured to store instructions for implementing a platform, language, database, and cloud agnostic APAM 406 for automatically and dynamically generating on-demand sequence of actions that integrate different frequently used computer implemented tools as disclosed herein. The APAD 402 may also include a medium reader (e.g., a medium reader 112 as illustrated in FIG. 1) which may be configured to read any one or more sets of instructions, e.g., software, from any of the memories described herein. The instructions, when executed by a processor embedded within the APAM 406 or within the APAD 402, may be used to perform one or more of the process 600s and processes as described herein. In a particular embodiment, the instructions may reside completely, or at least partially, within the memory 106, the medium reader 112, and/or the processor 104 (see FIG. 1) during execution by the APAD 402.

In some embodiments, the instructions, when executed, may cause a processor embedded within the APAM 406 or the APAD 402 to perform the following: establishing a communication link between an application and one or more computer implemented tools via a communication interface, wherein each computer implemented tool being configured to output data different from other computer implemented tool; receiving, by the application embedded within at least one processor, input data from a user via the communication interface, wherein the input data includes action model, initial state, and goals set by the user; dynamically creating the sequence of actions corresponding to the goals from the initial state by using an artificial intelligence planner included within the one or more computer implemented tools; executing the sequence of actions and checking for successful execution; recomputing the sequence of actions when a failure of successful execution is detected; and transmitting the recomputed sequence of actions to a display device utilized by the user. In some embodiments, the processor may be the same or similar to the processor 104 as illustrated in FIG. 1 or the processor embedded within the APAD 202, APAD 302, APAD 402, and APAM 406 which may be the same or similar to the processor 104.

In some embodiments, the instructions, when executed, may cause the processor 104 to further perform the following: calling the one or more computer implemented tools via corresponding API.

In some embodiments, the instructions, when executed, may cause the processor 104 to further perform the following: integrating the application to a first computer implemented tool among the one or more computer implemented tools that is configured for: reading an electronic mail, sending an electronic mail to another device, parsing electronic mail and replying to electronic mail.

In some embodiments, the instructions, when executed, may cause the processor 104 to further perform the following: integrating the application to a second computer implemented tool among the one or more computer implemented tools that may be configured for: creating a slide, adding a chart to the slide, adding a text to the slide, adding a table to the slide, creating a slide deck, and saving the slide deck.

In some embodiments, the instructions, when executed, may cause the processor 104 to further perform the following: integrating the application to a third computer implemented tool among the one or more computer implemented tools that may be configured for: reading a PDF file, extracting text from the PDF file, and saving a text file corresponding to the extracted text from the PDF file.

In some embodiments, the instructions, when executed, may cause the processor 104 to further perform the following: integrating the application to a fourth computer implemented tool among the one or more computer implemented tools that may be configured for: extracting all appointments data in connection with the user or a party the user wants to communicate with, adding appointment to a calendar within the fourth computer implemented tool.

In some embodiments, the instructions, when executed, may cause the processor 104 to further perform the following: integrating the application to a fifth computer implemented tool among the one or more computer implemented tools that may be configured for: reading a data file, extracting column contents from the data file, extracting column histogram from the data file, and saving the data file.

In some embodiments, the instructions, when executed, may cause the processor 104 to further perform the following: integrating the application to a sixth computer implemented tool among the one or more computer implemented tools that may be configured for: training a supervised machine learning model.

In some embodiments, the instructions, when executed, may cause the processor 104 to further perform the following: implementing a learning component that may adapt the supervised machine learning model according to an observed trace of execution.

In some embodiments, the instructions, when executed, may cause the processor 104 to further perform the following: redefining the goals set by the user when failures of execution are detected; and dynamically creating new sequence of actions corresponding to the redefined goals.

In some embodiments as disclosed above in FIGS. 1-5, technical improvements effected by the instant disclosure may include a platform for implementing a platform, language, database, and cloud agnostic automated planning assistant module configured to implement artificial intelligence techniques to automatically and dynamically generate a plan (sequence of actions) that may achieve goals specified by a user, execute the plan, monitor the execution of the plan, and replan when there is any failure in the execution, but the disclosure is not limited thereto. In some embodiments as disclosed above in FIGS. 1-5, technical improvements effected by the instant disclosure may include a platform for implementing a platform, language, database, and cloud agnostic automated planning assistant module configured to implement artificial intelligence techniques to automatically and dynamically: generate on-demand processes (plans) that integrate different frequently used tools; execute those processes, checking for successful execution; recompute processes when failures of execution are detected; redefine process goals when needed; integrate capabilities into a generic framework that easily allows including new tools, etc., thereby adding simplicity to the overall system or process, resolving data integration or synchronization or transfer issues among various computer implemented tools having various heterogenous systems running therein and protecting the overall system and network from being attacked by malicious systems, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, process 600s, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or process 600s described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for automatically and dynamically generating on-demand sequence of actions that integrate different frequently used computer implemented tools by utilizing one or more processors along with allocated memory, the method comprising:
establishing a communication link between an application and one or more computer implemented tools via a communication interface, wherein each computer implemented tool being configured to output data different from other computer implemented tool;
receiving, by the application embedded within at least one processor, input data from a user via the communication interface, wherein the input data includes action model, initial state, and goals set by the user;
dynamically creating the sequence of actions corresponding to the goals from the initial state by using an artificial intelligence planner included within the one or more computer implemented tools;
executing the sequence of actions and checking for successful execution;
recomputing the sequence of actions when a failure of successful execution is detected; and
transmitting the recomputed sequence of actions to a display device utilized by the user.

2. The method according to claim 1, further comprising:
calling the one or more computer implemented tools via corresponding Application Programming Interface (API).

3. The method according to claim 1, further comprising:
integrating the application to a first computer implemented tool among the one or more computer implemented tools that is configured for:
reading an electronic mail, sending an electronic mail to another device, parsing electronic mail and replying to electronic mail.

4. The method according to claim 1, further comprising:
integrating the application to a second computer implemented tool among the one or more computer implemented tools that is configured for:
creating a slide, adding a chart to the slide, adding a text to the slide, adding a table to the slide, creating a slide deck, and saving the slide deck.

5. The method according to claim 1, further comprising:
integrating the application to a third computer implemented tool among the one or more computer implemented tools that is configured for:
reading a Portable Document Format (PDF) file, extracting text from the PDF file, and saving a text file corresponding to the extracted text from the PDF file.

6. The method according to claim 1, further comprising:
integrating the application to a fourth computer implemented tool among the one or more computer implemented tools that is configured for:
extracting all appointments data in connection with the user or a party the user wants to communicate with, adding appointment to a calendar within the fourth computer implemented tool.

7. The method according to claim 1, further comprising:
integrating the application to a fifth computer implemented tool among the one or more computer implemented tools that is configured for:
reading a data file, extracting column contents from the data file, extracting column histogram from the data file, and saving the data file.

8. The method according to claim 1, further comprising:
integrating the application to a sixth computer implemented tool among the one or more computer implemented tools that is configured for:
training a supervised machine learning model.

9. The method according to claim 8, further comprising:
implementing a learning component that adapts the supervised machine learning model according to an observed trace of execution.

10. The method according to claim 1, further comprising:
redefining the goals set by the user when failures of execution are detected; and
dynamically creating new sequence of actions corresponding to the redefined goals.

11. A system for automatically and dynamically generating on-demand sequence of actions that integrate different frequently used computer implemented tools, the system comprising:
a processor; and
a memory operatively connected to the processor via a communication interface, the memory storing computer readable instructions, when executed, causes the processor to:
establish a communication link between an application and one or more computer implemented tools via the communication interface, wherein each computer implemented tool being configured to output data different from other computer implemented tool;
receive, by the application embedded within the processor, input data from a user via the communication interface, wherein the input data includes action model, initial state, and goals set by the user;
dynamically create the sequence of actions corresponding to the goals from the initial state by using an artificial intelligence planner included within the one or more computer implemented tools;
execute the sequence of actions and checking for successful execution;
recompute the sequence of actions when a failure of successful execution is detected; and
transmit the recomputed sequence of actions to a display device utilized by the user.

12. The system according to claim 11, wherein the processor is further configured to:
call the one or more computer implemented tools via corresponding Application Programming Interface (API).

13. The system according to claim 11, wherein the processor is further configured to integrate the application to a first computer implemented tool among the one or more computer implemented tools that is configured for:
reading an electronic mail, sending an electronic mail to another device, parsing electronic mail and replying to electronic mail.

14. The system according to claim 11, wherein the processor is further configured to integrate the application to a second computer implemented tool among the one or more computer implemented tools that is configured for:
creating a slide, adding a chart to the slide, adding a text to the slide, adding a table to the slide, creating a slide deck, and saving the slide deck.

15. The system according to claim 11, wherein the processor is further configured to integrate the application to a third computer implemented tool among the one or more computer implemented tools that is configured for:
reading a Portable Document Format (PDF) file, extracting text from the PDF file, and saving a text file corresponding to the extracted text from the PDF file.

16. The system according to claim 11, wherein the processor is further configured to integrate the application to a fourth computer implemented tool among the one or more computer implemented tools that is configured for:
extracting all appointments data in connection with the user or a party the user wants to communicate with, adding appointment to a calendar within the fourth computer implemented tool.

17. The system according to claim 11, wherein the processor is further configured to integrate the application to a fifth computer implemented tool among the one or more computer implemented tools that is configured for:
reading a data file, extracting column contents from the data file, extracting column histogram from the data file, and saving the data file.

18. The system according to claim 11, wherein the processor is further configured to integrate the application to a sixth computer implemented tool among the one or more computer implemented tools that is configured for:
training a supervised machine learning model.

19. The system according to claim 18, wherein the processor is further configured to implement a learning component that adapts the supervised machine learning model according to an observed trace of execution.

20. A non-transitory computer readable medium configured to store instructions for automatically and dynamically generating on-demand sequence of actions that integrate different frequently used computer implemented tools, the instructions, when executed, cause a processor to perform the following:
establishing a communication link between an application and one or more computer implemented tools via a communication interface, wherein each computer implemented tool being configured to output data different from other computer implemented tool;
receiving, by the application embedded within at least one processor, input data from a user via the communication interface, wherein the input data includes action model, initial state, and goals set by the user;
dynamically creating the sequence of actions corresponding to the goals from the initial state by using an artificial intelligence planner included within the one or more computer implemented tools;
executing the sequence of actions and checking for successful execution;
recomputing the sequence of actions when a failure of successful execution is detected; and
transmitting the recomputed sequence of actions to a display device utilized by the user.
